(19) United States
(12) Patent Application Publication
(10) Pub. No.: US 2023/0420824 A1
(43) Pub. Date: Dec. 28, 2023

(54) ANTENNA DEVICE

(71) Applicant: Yazaki Corporation, Tokyo (JP)

(72) Inventor: Kazuhiko Tsuchiya, Shizuoka (JP)

(73) Assignee: Yazaki Corporation, Tokyo (JP)

(21) Appl. No.: 18/341,213

(22) Filed: Jun. 26, 2023

(30) Foreign Application Priority Data
Jun. 27, 2022 (JP) 2022-102499

(51) Int. Cl. H01Q 1/22

(52) U.S. Cl. CPC H01Q 1/2283

(57) ABSTRACT

An antenna device includes: an antenna substrate; an antenna element; a holder that is fixed to the antenna substrate to thereby hold an antenna unit; and a first case having electrical insulating properties and forming a part of a housing that houses the antenna element. Further, the antenna element includes: an antenna unit that is arranged at a position separated by a predetermined length from a substrate surface of the antenna substrate, in such a way as to be parallel to the substrate surface; and a grounding unit that is connected continuous to the antenna unit and electrically connected to the antenna substrate. In a state in which the antenna element is housed in the housing, a fitting protrusion of the holder penetrates into a fitting hole that is formed in the antenna unit to abut on an inner surface of the first case.

### CROSS-REFERENCE TO RELATED APPLICATIONS

The present application is based on, and claims priority from the prior Japanese Patent Application No. 2022-102499, filed on Jun. 27, 2022, the entire contents of which are incorporated herein by reference.

### TECHNICAL FIELD

The present disclosure relates to an antenna device.

### BACKGROUND

JP 2000-022431 A discloses an antenna device that includes a radiating element, a ground plate provided electrically distant from the radiating element, and a cover member covering the radiating element.

Further, JP 2000-022431 A discloses that a spacer is arranged between the radiating element and the ground plate, and thus the radiating element can be held in a state in which the space between the radiating element and the ground plate is kept at a predetermined height. By mounting the antenna device in a mobile body such as an aircraft, a ship, or an automobile, mobile satellite communication can be performed between the mobile body and a communication satellite, for example.

### SUMMARY OF THE INVENTION

However, in the above prior technology, a recess for mounting is provided in at least one of the ground plate and the radiating element, and the spacer is fitted into the recess to hold the radiating element at a predetermined height. Therefore, when vibrations in the height direction occur in the antenna device due to shaking of the mobile body or the like, there is a risk that the radiating element may deviate in the height direction.

For this reason, the above prior antenna device is not configured to adequately withstand vibrations. In the case of an antenna device in which the radiating element and the ground plate are arranged at a predetermined distance from each other, it is preferable to have a configuration that is capable of withstanding vibrations as much as possible.

However, if the antenna characteristics are greatly degraded by having a configuration that is capable of withstanding vibrations, the antenna device is not able to function as an antenna sufficiently.

Therefore, it is preferable to have a configuration that is capable of withstanding vibrations as much as possible and suppressing degradation in antenna characteristics.

An object of the present disclosure is to provide an antenna device that is capable of withstanding vibrations and suppressing degradation in antenna characteristics.

An antenna device according to an embodiment includes: an antenna substrate; an antenna element including an antenna unit that is arranged at a position separated by a predetermined length in a first direction that is perpendicular to a substrate surface of the antenna substrate from the substrate surface, in such a way as to be parallel to the substrate surface of the antenna substrate, and a grounding unit that is connected continuous to the antenna unit and electrically connected to the antenna substrate; a first case having electrical insulating properties and forming a part of a housing that houses the antenna element; and a columnar holder that is elongated in the first direction and fixed to the antenna substrate to thereby hold the antenna unit. The antenna unit is formed with a fitting hole that penetrates in the first direction, the holder is formed with a fitting protrusion that is fitted into the fitting hole, and in a state in which the antenna element is housed in the housing, the fitting protrusion penetrates into the fitting hole to abut on an inner surface of the first case.

The above configuration makes it possible to provide an antenna device that is capable of withstanding vibrations and suppressing degradation in antenna characteristics.

### BRIEF DESCRIPTION OF DRAWINGS

FIG. 1 is an exploded perspective view illustrating an example of an antenna device according to an embodiment.

FIG. 2 is a partially broken perspective view illustrating an example of the antenna device according to the embodiment.

FIG. 3 is an enlarged cross-sectional view of portion A of FIG. 2.

FIG. 4 is a perspective view illustrating an example of a holder that is used in the antenna device according to the embodiment.

FIG. 5 is a perspective view illustrating a holder according to a comparative example, which illustrates a state before holding an antenna element.

FIG. 6 is a perspective view illustrating a state in which the antenna element is held using the holder according to the comparative example.

FIG. 7 is a graph illustrating the frequency characteristics of the voltage standing wave ratios of the antenna device according to the embodiment and the antenna device according to the comparative example.

FIG. 8 is a graph illustrating a relationship between the diameters of the holder and the frequency characteristics of the voltage standing wave ratios which are used in the antenna device according to the embodiment.

### DETAILED DESCRIPTION OF THE INVENTION

Various embodiments will be described hereinafter with reference to the accompanying drawings.

Hereafter, an antenna device according to the present embodiment will be described in detail with reference to the drawings. Note that the dimensional ratios in the drawings are exaggerated for convenience of the explanation and may differ from the actual ratios.

In the following, an example of an in-vehicle antenna device installed in a vehicle as an antenna device will be described by defining the longitudinal direction of the antenna device as the X-direction, the lateral direction of the antenna device as the Y-direction, and the thickness direction of the antenna device as the Z-direction.

An in-vehicle antenna device (antenna device) 1 according to the present embodiment may be, for example, a device that notifies a call center outside a vehicle of the condition and position information of the vehicle when an abnormality occurs in the vehicle, and that also makes it possible to make an emergency call to the call center.

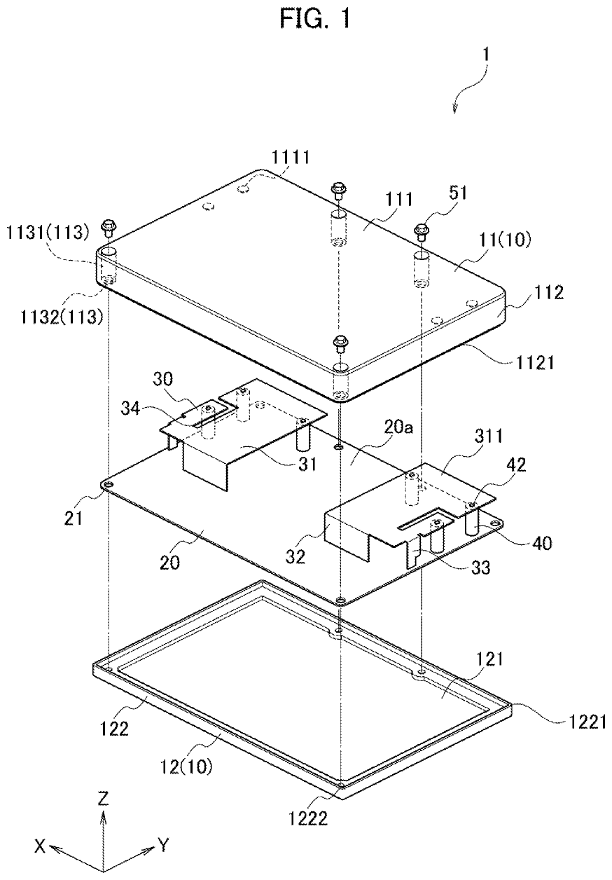

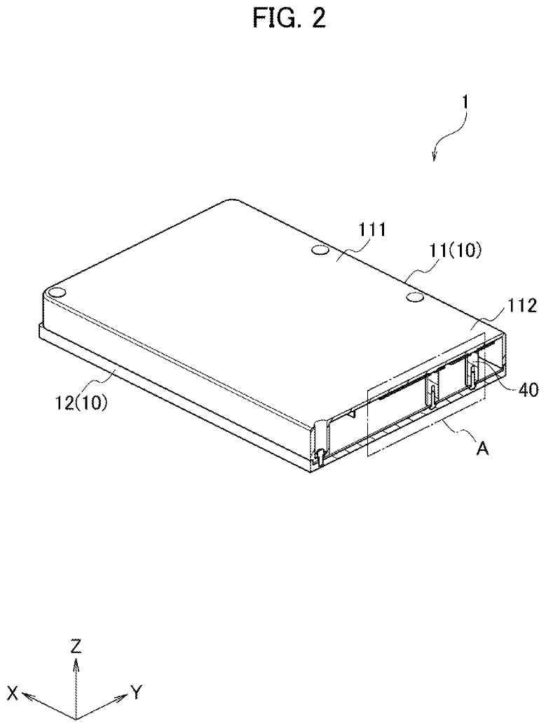

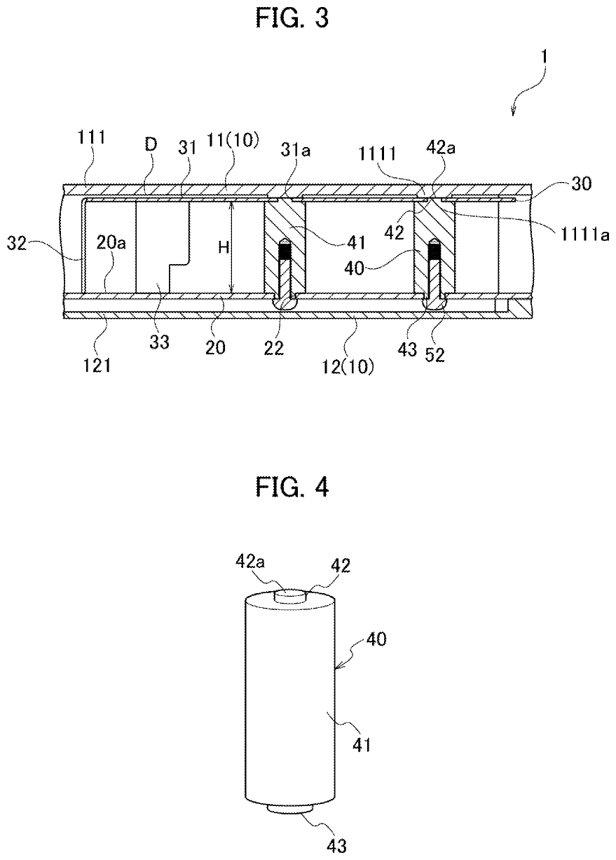

In the present embodiment, the in-vehicle antenna device 1 includes a circuit substrate (antenna substrate) 20 and an antenna element 30 that is connected to the circuit substrate 20, as illustrated in FIGS. 1 and 2. The 10 antenna device 1 also includes a housing 10 in which the circuit substrate 20 and the antenna element 30 are housed.

The housing 10 is approximately rectangular in shape, and includes a resin upper case (first case) 11 and a metal lower case (second case) 12. The upper case 11 is provided with an approximately rectangular plate-shaped top wall 111 and a peripheral wall 112 extending downward from the outer peripheral edge of the top wall 111. The lower case 12 is provided with an approximately rectangular plate-shaped bottom wall 121 and a peripheral wall 122 extending upward from the outer peripheral edge of the bottom wall 121.

By fixing the upper case 11 and the lower case 12 to each other, the housing 10 is formed having a space formed therein. In the present embodiment, a lower end 1121 of the peripheral wall 112 of the upper case 11 is formed only on the inner peripheral side, and an upper end 1221 of the peripheral wall 122 of the lower case 12 is formed only on the outer peripheral side. Thus, when the upper case 11 and the lower case 12 are fixed to each other, the lower end 1121 of the peripheral wall 112 of the upper case 11 is fitted into the upper end 1221 of the peripheral wall 122 of the lower case 12.

Further, in the present embodiment, screws 51 are used to fix the upper case 11 and the lower case 12. More specifically, fixing parts 113 fixed by the screws 51 are formed at the outer peripheral edges of the top wall 111 of the upper case 11. In the present embodiment, the fixing parts 113 are formed by housing recesses 1131 in which the screws 51 are housed, and insertion holes 1132 formed at the lower ends of the housing recesses 1131 so as to penetrate in the Z-direction (up-down direction: first direction).

Further, screw-fixing recesses 1222 are formed at positions, which are opposite to the insertion holes 1132, in the outer peripheral edges of the bottom wall 121 of the lower case 12. The screws 51 are inserted into the insertion holes 1132 and screwed into the screw-fixing recesses 1222, and thus the upper case 11 and the lower case 12 are fixed to each other by the screws 51.

When the housing 10 is formed by fixing the upper case 11 and the lower case 12, the circuit substrate 20 to which the antenna element 30 is electrically connected is housed inside the housing 10. In the present embodiment, the circuit substrate 20 is housed inside the housing 10 in a state in which the antenna element 30 is positioned on the upper side. Thus, in the present embodiment, the in-vehicle antenna device 1 includes the upper case (first case) 11 having electrical insulating properties and forming a part of the housing 10 that houses the antenna element 30.

Further, in the present embodiment, insertion holes 21 are formed at positions, which are opposite to the insertion holes 1132 and the screw-fixing recesses 1222, in the circuit substrate 20. When the upper case 11 and the lower case 12 are fixed to each other by the screws 51, the circuit substrate 20 is also configured to be fixed by the screws 51. This suppresses movement of the circuit substrate 20 within the housing 10 relative to the housing 10.

The circuit substrate 20 has an approximately rectangular plate shape, and the antenna element 30 is electrically connected to a surface 20a of the circuit substrate 20 (substrate surface). An amplifier circuit, an electrolytic capacitor, or the like may be mounted on the circuit substrate 20, depending on the intended use of the in-vehicle antenna device 1.

The antenna element 30 has an antenna unit 31. The antenna unit 31 is arranged at a position separated by a predetermined length H in the first direction (up-down direction: Z-direction), in such a way as to be parallel to the surface 20a of the circuit substrate 20. Specifically, a portion extending in the first direction (up-down direction: Z-direction) is provided at a peripheral part 311 of the antenna unit 31, and the portion extending in the first direction (up-down direction: Z-direction) is fixed to the circuit substrate 20 by soldering or the like. Thus, the antenna unit 31 is arranged at the position separated by the predetermined length H in the first direction (up-down direction: Z-direction), in such a way as to be parallel to the surface 20a of the circuit substrate 20.

Further, in the present embodiment, the portion extending in the first direction (up-down direction: Z-direction) is electrically connected to the circuit substrate 20, which causes the portion to function as a grounding unit 32 and a feeding unit 33. Specifically, the portion extending in the X-direction and the Z-direction is electrically connected to a ground pattern of the circuit substrate 20, which causes the portion to function as the grounding unit 32. In addition, the portion extending in the Y-direction and the Z-direction is electrically connected to a feeding pattern of the circuit substrate 20, which causes the portion to function as the feeding unit 33.

Thus, in the present embodiment, the antenna element 30 has the antenna unit 31, the grounding unit 32 that is connected continuous to the antenna unit 31 and electrically connected to the circuit substrate 20, and the feeding unit 33 that is connected continuous to the antenna unit 31 and electrically connected to the circuit substrate 20.

In addition, an approximately L-shaped slit 34 is formed in the antenna unit 31, and thus the antenna unit 31 is divided into a plurality of areas. The plurality of areas function as antenna elements having different frequency bands. Accordingly, the in-vehicle antenna device 1 can communicate in multiple frequency bands.

The antenna element 30 having such a shape can be formed, for example, by punching out a single metal plate by means of pressing, or by bending a single metal plate at an almost right angle.

Further, in the present embodiment, a pair of antenna elements 30 are electrically connected to the circuit substrate 20, and the pair of antenna elements 30 are arranged so as to be linearly symmetric with respect to a straight line extending in the Y-direction.

The pair of antenna elements 30 arranged in this way can be used, for example, as a TEL antenna to realize communication with a call center (network server) providing emergency call services via a mobile phone communication network.

When the pair of antenna elements 30 are used as a TEL antenna, the predetermined length H indicating the distance between the antenna unit 31 and the circuit substrate 20 can be determined by the following method, for example. That is, the predetermined length H can be determined by optimizing the length on the basis of the relationship between the wavelength of the frequency band corresponding to each antenna element and the peripheral components affecting each antenna element.

Incidentally, when the in-vehicle antenna device 1 including the antenna element 30 having the shape described above is installed in a vehicle, the in-vehicle antenna device 1 vibrates due to the vibrations of the vehicle caused by the travel of the vehicle. When the in-vehicle antenna device 1 vibrates, the antenna unit 31 moves relative to the housing 10, and thus the distance between the antenna unit 31 and the surface 20a of the circuit substrate 20 changes in some cases. That is, in some cases, the antenna unit 31 cannot be held at the position separated by the predetermined length H in the first direction (up-down direction: Z-direction) from the surface 20a of the circuit substrate 20. If the antenna unit 31 cannot be held at the position separated by the predetermined length H, the antenna characteristics of the in-vehicle antenna device 1 may degrade.

Accordingly, the present embodiment makes it possible to more reliably suppress degradation in the antenna characteristics of the in-vehicle antenna device 1.

Specifically, a holder 40 is arranged between the circuit substrate 20 and the antenna unit 31, and the holder 40 allows the antenna unit 31 to maintain the distance between the antenna unit 31 and the surface 20a of the circuit substrate 20 at the predetermined length H.

The holder 40 is made of resin with electrical insulating properties such that the influence on the antenna characteristics of the antenna unit 31 becomes relatively small. In this case, it is preferable to form the holder 40 using a resin material with a low dielectric constant, or a resin material with a low dielectric tangent.

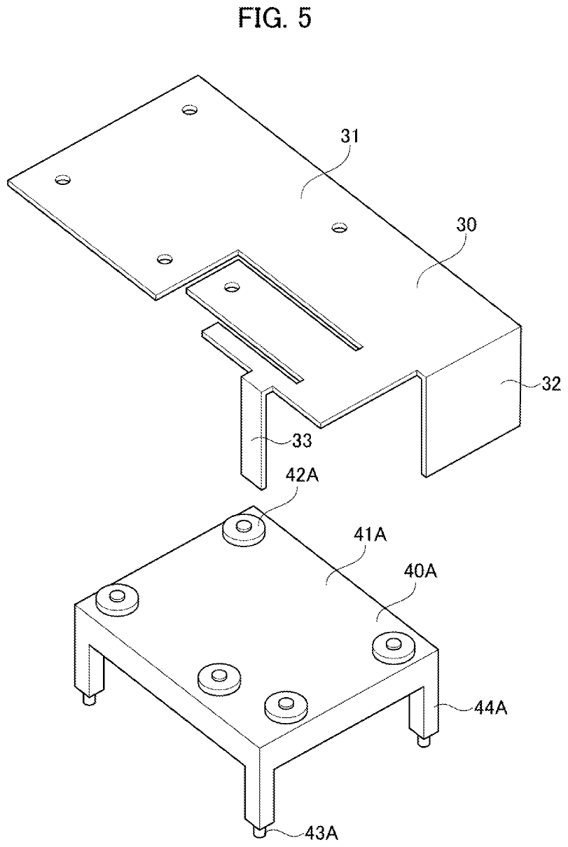

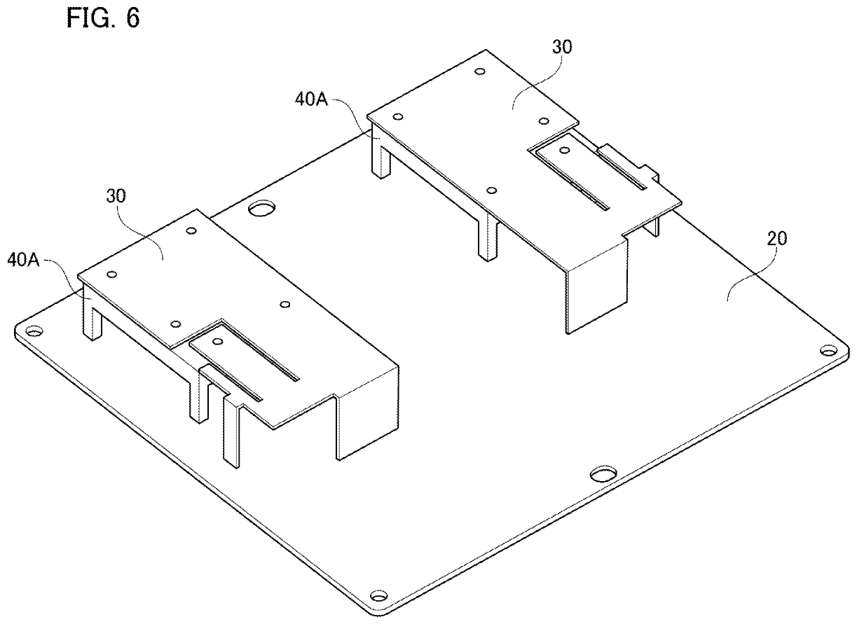

It is also conceivable to use a holder 40A illustrated in FIG. 5 and FIG. 6 in order for the antenna unit 31 to be held at the position separated by the predetermined length H.

The holder 40A illustrated in FIG. 5 and FIG. 6 includes an approximately rectangular plate-shaped main body 41A extending along the XY plane orthogonal to the up-down direction, and a plurality of approximately cylindrical fitting protrusions 42A are formed on the upper surface of the main body 41A in such a way as to protrude upward.

By fitting the fitting protrusions 42A into the antenna unit 31, the antenna unit 31 is held at the position separated by the predetermined length H. At this time, the plurality of fitting protrusions 42A are fitted into portions of the antenna unit 31 that are relatively easy to displace in the up-down direction. This makes it possible to more reliably suppress displacement of the antenna unit 31 in the up-down direction.

In addition, legs 44A are formed at the four corners of the main body 41A in such a way as to protrude downward, and each leg part 44A has a fitting protrusion 43A that is fitted into the circuit substrate 20 and is formed in such a way as to protrude downward.

However, when the holder 40A illustrated in FIG. 5 and FIG. 6 is used, the holder 40 occupies a large proportion of the space between the antenna unit 31 and the circuit substrate 20, which has a greater influence on the antenna characteristics of the antenna device 1, as will be described below.

For this reason, in the present embodiment, the holder 40 is designed to have a configuration that is capable of withstanding vibrations when the antenna device 1 is mounted in a vehicle and reducing the influence on the antenna characteristics of the antenna device 1 as much as possible.

Specifically, as illustrated in FIG. 4, the holder 40 includes an approximately cylindrical main body 41 that is elongated in the first direction (up-down direction: Z-direction) that is perpendicular to the substrate surface 20a of the circuit substrate 20. Accordingly, by using the columnar holder 40 that is elongated in the first direction (up-down direction: Z-direction), the influence on the antenna characteristics of the antenna device 1 that is caused by the holder 40 can be reduced as much as possible.

At the upper end of the main body 41, a fitting protrusion 42 smaller in diameter than the main body 41 is formed to protrude upward. Similarly, at the lower end of the main body 41, a fitting protrusion 43 smaller in diameter than the main body 41 is formed to protrude downward.

In the present embodiment, the circuit substrate 20 is formed with an insertion hole 22 into which the fitting protrusion 43 is fitted, and the holder 40 is fixed to the circuit substrate 20 by a resin screw 52 in a state in which the fitting protrusion 43 is fitted into the insertion hole 22.

In addition, the antenna unit 31 is formed with a fitting hole 31a into which the fitting protrusion 42 is fitted. By fitting the fitting protrusion 42 of the holder 40 into the fitting hole 31a, movement of the antenna unit 31 in the XY plane that is orthogonal to the up-down direction (deviation in the horizontal direction) can be suppressed.

Further, in the present embodiment, in a state in which the antenna element 30 is housed in the housing 10, a tip surface 42a of the fitting protrusion 42 penetrates into the fitting hole 31a to abut on the inner surface of the upper case 11. That is, the antenna unit 31 is sandwiched between the holder 40 and the upper case 11. This makes it possible to suppress movement of the antenna unit 31 in the up-down direction (deviation in the up-down direction) due to vibrations or the like.

Since movement of the antenna unit 31 in the XY plane and in the up-down direction is suppressed as described above, the antenna device 1 is configured to withstand vibrations when mounted in a vehicle.

Further, in the present embodiment, on the top wall 111 of the upper case 11, a circular protrusion 1111 that protrudes downward is provided at the portion abutting on the tip surface 42a of the fitting protrusion 42. A lower surface 1111a of the circular protrusion 1111 (inner surface of the upper case 11) is configured to abut on the tip surface 42a of the fitting protrusion 42. As a result, a gap D is formed between the top wall 111 and a portion of the antenna unit 31 where the holder 40 is not arranged, and this gap D makes it possible to reduce the influence of the top wall 111 on the antenna characteristics of the antenna device 1 as much as possible.

Further, in the present embodiment, the holder 40 is arranged in the peripheral part 311 of the antenna unit 31. Specifically, three holders 40 are arranged separated from each other along the peripheral part 311 of each antenna unit 31. At this time, the portions of the antenna unit 31 that are relatively easy to displace in the up-down direction are held by these three holders 40. That is, the fitting protrusions 42 of the three holders 40 are fitted into the portions of the antenna unit 31 that are relatively easy to displace in the up-down direction.

This makes it possible to more reliably suppress displacement of the antenna unit 31 in the up-down direction and reduce the influence of the holder 40 on the antenna characteristics of the antenna device 1 as much as possible. In addition, this makes it possible to more reliably suppress degradation in the antenna characteristics of the antenna device 1.

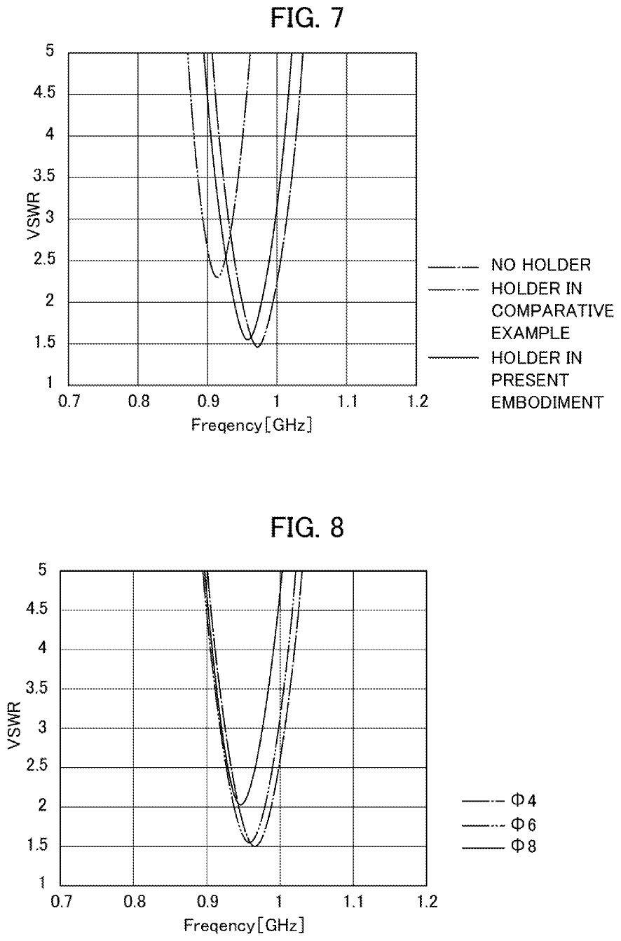

For example, as illustrated in FIG. 7, it can be confirmed that when the holder is provided between the circuit substrate 20 and the antenna unit 31, the influence on the antenna characteristics (frequency deviation, efficiency) becomes greater than when the holder is not provided therebetween.

FIG. 7 is a graph illustrating the frequency characteristics of the voltage standing wave ratios (VSWR) of the in-vehicle antenna device 1. FIG. 7 illustrates the respective measurement results of the VSWR characteristics acquired when no holder is provided, when the holder 40 according to the present embodiment is provided, and when a holder according to a comparative example (that is, the holder 40A illustrated in FIG. 5 and FIG. 6) is provided.

From the measurement results in FIG. 7, it can be confirmed that even when the holder is provided between the circuit substrate 20 and the antenna unit 31, the influence on the antenna characteristics when the holder 40 according to the present embodiment is provided is less than when the holder 40A illustrated in FIG. 5 and FIG. 6 is provided. That is, when the holder 40 according to the present embodiment is provided, the in-vehicle antenna device 1 can be configured to withstand vibrations when mounted in a vehicle and suppress the influence on the antenna characteristics.

In addition, when the holder 40 according to the present embodiment is provided, as illustrated in FIG. 8, it can be confirmed that the influence on the antenna characteristics is less when the holder 40 is thin (the length of the diameter is short). That is, it can be confirmed that the antenna characteristics decrease in frequency and the efficiency degrades as the outer diameter of the holder 40 increases. FIG. 8 illustrates the respective measurement results of the VSWR characteristics acquired when a holder 40 with a diameter of 4 mm is used, when a holder 40 with a diameter of 6 mm is used, and when a holder 40 with a diameter of 8 mm is used.

For this reason, it is preferable to use a thin holder 40 (the length of the diameter is short) in order to reduce the influence on the antenna characteristics. However, it is preferable to use a thick holder 40 (the length of the diameter is long) in consideration of deformation/buckling due to load during vibration.

Therefore, in the present embodiment, a holder 40 with a diameter of 6 mm is used such that the in-vehicle antenna device 1 has a configuration that is capable of withstanding vibrations when mounted in a vehicle and reducing the influence on the antenna characteristics.

Thus, in the antenna device 1 according to the present embodiment, it is possible to suppress deviation of the antenna unit 31 in the X-direction, the Y-direction, and the Z-direction even when vibrations or the like occur. As a result, it is possible to hold the antenna unit 31 at the position separated by the predetermined length H from the substrate surface 20a of the circuit substrate 20. Further, movement of the antenna unit 31 is suppressed in the up-down direction by sandwiching the antenna unit 31 between the holder 40 and the upper case 11, and thus it is not necessary to separately provide a member between the antenna unit 31 and the upper case 11 to suppress movement of the antenna unit 31 in the up-down direction. This makes it possible to reduce the antenna device 1 in height.

### [Function and Effect]

In the following description, the characteristic configuration of the antenna device described in the above embodiment and the effect obtained therefrom will be described.

The antenna device 1 described in the above embodiment includes the circuit substrate (antenna substrate) 20 and the antenna element 30 that is connected to the circuit substrate 20. Further, the antenna device 1 includes the upper case (first case) 11 having electrical insulating properties and forming a part of the housing 10 that houses the antenna element 30. Further, the antenna device 1 includes the columnar holder 40 that is elongated in the first direction (up-down direction: Z-direction) that is perpendicular to the substrate surface 20a of the circuit substrate 20. The holder 40 is fixed to the circuit substrate 20 to thereby hold the antenna unit 31.

The antenna element 30 has the antenna unit 31 that is arranged at the position separated by the predetermined length H in the first direction (up-down direction: Z-direction) from the substrate surface 20a, in such a way as to be parallel to the substrate surface 20a of the circuit substrate 20. In addition, the antenna element 30 has the grounding unit 32 that is connected continuous to the antenna unit 31 and electrically connected to the circuit substrate 20.

In addition, the antenna unit 31 is formed with the fitting hole 31a that penetrates in the up-down direction, and the holder 40 is formed with the fitting protrusion 42 that is fitted into the fitting hole 31a.

In a state in which the antenna element 30 is housed in the housing 10, the fitting protrusion 42 penetrates into the fitting hole 31a to abut on the inner surface 1111a of the upper case 11.

In the antenna device 1 described in the above embodiment, the fitting protrusion 42 that is formed in the holder 40 is fitted into the fitting hole 31a that is formed in the antenna unit 31. This makes it possible to suppress movement of the antenna unit 31 in the XY plane orthogonal to the up-down direction (deviation in the horizontal direction) due to vibrations or the like.

Further, in the antenna device 1 described in the above embodiment, in a state in which the antenna element 30 is housed in the housing 10, the fitting protrusion 42 penetrates into the fitting hole 31a to abut on the inner surface 1111a of the upper case 11. That is, the antenna unit 31 is sandwiched between the holder 40 and the upper case 11. This makes it possible to suppress movement of the antenna unit 31 in the up-down direction (deviation in the up-down direction) due to vibrations or the like.

Thus, in the antenna device 1 according to the present embodiment, it is possible to hold the antenna unit 31 at the position separated by the predetermined length H from the substrate surface 20a of the circuit substrate 20 even when vibrations or the like occur. As a result, the present embodiment makes it possible to more reliably suppress degradation in the antenna characteristics of the in-vehicle antenna device 1.

Further, in the antenna device 1 described in the above embodiment, the columnar holder 40 that is elongated in the up-down direction is used to hold the antenna unit 31 at the position separated by the predetermined length H from the substrate surface 20a of the circuit substrate 20. This makes it possible to reduce, as much as possible, the proportion of the space between the antenna unit 31 and the circuit substrate 20 occupied by the holder 40, and to hold the antenna unit 31 at the position separated by the predetermined length H from the substrate surface 20a of the circuit substrate 20. As a result, the present embodiment makes it possible to more reliably suppress degradation in the antenna characteristics of the in-vehicle antenna device 1.

Further, in the antenna device 1 described in the above embodiment, movement of the antenna unit 31 is suppressed in the up-down direction by sandwiching the antenna unit 31 between the holder 40 and the upper case 11. Thus, it is not necessary to separately provide a member between the antenna unit 31 and the upper case 11 to suppress movement of the antenna unit 31 in the up-down direction, thereby making it possible to further reduce the antenna device 1 in height.

Thus, in the antenna device 1 according to the present embodiment, it is possible to reduce the antenna device 1 in height and also have a configuration that is capable of withstanding vibrations. Further, it is possible to more reliably suppress degradation in the antenna characteristics of the antenna device 1.

In addition, the holder 40 may be arranged in the peripheral part 311 of the antenna unit 31.

This makes it possible to reduce the influence of the holder 40 on the antenna characteristics of the antenna device 1 as much as possible, thereby making it possible to more reliably suppress degradation in the antenna characteristics of the antenna device 1.

### [Other Matters]

Although the present embodiment has been described as above, the present embodiment is not limited to these configurations and various modifications are possible within the scope of the gist of the present embodiment.

For example, the configurations described in the above embodiment may be combined as appropriate.

In the above embodiment, the in-vehicle antenna device 1 has been described as an example in which only the pair of antenna elements 30 are connected to the circuit substrate however, the present invention may also be applied to antenna devices having various types of antennas.

In the above embodiment, the holder 40 having a cylindrical shape is used as an example, but it is not necessary to have a cylindrical shape. For example, the holder 40 may have various types of shapes such as a quadrilateral shape.

In the above embodiment, all the holders 40 used have the same shapes and thicknesses; however, the shape and thickness of a holder 40 may be changed according to the shape of the antenna unit 31 in which the holder 40 is arranged.

Further, the present invention may be applied to antenna devices other than an in-vehicle antenna device that is installed in a vehicle. For example, the present invention may be applied to antenna devices mounted in a mobile body such as an aircraft or a ship, and the present invention may also be applied to antenna devices mounted in a device or the like in which vibrations occur despite not being a device for moving.

In addition, the specifications (shape, size, layout, etc.) of the holders, antenna elements, and other particulars may also be changed as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An antenna device comprising:
an antenna substrate;
an antenna element including an antenna unit that is arranged at a position separated by a predetermined length in a first direction that is perpendicular to a substrate surface of the antenna substrate from the substrate surface, in such a way as to be parallel to the substrate surface of the antenna substrate, and a grounding unit that is connected continuous to the antenna unit and electrically connected to the antenna substrate;
a first case having electrical insulating properties and forming a part of a housing that houses the antenna element; and
a columnar holder that is elongated in the first direction and fixed to the antenna substrate to thereby hold the antenna unit, wherein
the antenna unit is formed with a fitting hole that penetrates in the first direction,
the holder is formed with a fitting protrusion that is fitted into the fitting hole, and
in a state in which the antenna element is housed in the housing, the fitting protrusion penetrates into the fitting hole to abut on an inner surface of the first case.

2. The antenna device according to claim 1, wherein
the holder is arranged in a peripheral part of the antenna unit.
